(19) United States
(12) Patent Application Publication
(10) Pub. No.: US 2023/0064615 A1
(43) Pub. Date: Mar. 2, 2023

(54) METHOD FOR TRAINING AN IMAGE ANALYSIS NEURAL NETWORK, AND OBJECT RE-IDENTIFICATION METHOD IMPLEMENTING SUCH A NEURAL NETWORK

(71) Applicant: BULL SAS, Les Clayes-sous-Bois (FR)

(72) Inventor: Matthieu OSPICI, GRENOBLE (FR)

(73) Assignee: BULL SAS, Les Clayes-sous-Bois (FR)

(21) Appl. No.: 17/901,135

(22) Filed: Sep. 1, 2022

(30) Foreign Application Priority Data
Sep. 2, 2021 (EP) 21306198.9

(51) Int. Cl. G06N 3/08; G06T 1/00

(52) U.S. Cl. CPC G06N 3/082; G06N 3/084; G06T 1/0021

(57) ABSTRACT

A computer-implemented method for training a neural network providing a digital signature for each image given as input to the neural network. The method includes a first training phase of the neural network with a set of training images and a training algorithm aiming to minimize a first cost function. The method also includes a second training phase including at least one iteration of providing an image originating from said set of training images to said neural network in order to obtain a so-called real signature, generating at least one so-called artificial signature from said real signature, calculating an error based upon said real and artificial signatures, and updating at least one layer of said neural network, based upon said error, in order to minimize a second cost function. A neural network trained by the method and to a method for object re-identification on images implementing the neural network.

This application claims priority to European Patent Application Number 21306198.9, filed 2 Sep. 2021, the specification of which is hereby incorporated herein by reference.

### BACKGROUND OF THE INVENTION

### Field of the Invention

At least one embodiment of the invention relates to a method for training an image analysis neural network, in particular a regression image analysis neural network. It also relates to a neural network obtained by such a method and to an object re-identification method implementing such a neural network.

The field of the invention is generally the field of neural networks for image processing, in particular by regression, and more particularly of neural networks used for object re-identification in images.

### Description of the Related Art

In recent years, systems based on deep neural networks have proven to be extremely efficient in the context of re-identification of persons or objects in images. The best systems use a neural network whose architecture is based on convolutions, for example the Resnet50 architecture.

Before its use, the neural network is trained on a data set which has the objective of optimizing a cost function that can be double, that is to say a function taking into account a double error, namely a “triplet loss”, or an “identification loss”. The cost function is generally the sum of the errors obtained for all the images in the training set, and the training aims to minimize said cost function. Once the neural network has been trained, an image is given as input to the neural network, which provides a digital “signature” as output. The similarity between two images is determined by calculating a distance, for example a Euclidean distance or a cosine distance, between the signatures of these images.

The set of training images used is generally a set of images from the academic world. However, the performance of a neural network trained in this way drops when it is used on real images that vary slightly from those of the training set, for example in the case of differences in brightness or viewing angle between the training images and the real image. The drop in performance can be as much as 60%, which is considerable.

One purpose of the invention is to remedy this shortcoming.

Another purpose of the invention is to propose a solution for training a neural network used for image processing that has more stable performance.

Another purpose of the invention is to propose a solution for training a neural network used for image processing in which the performance obtained using real images decreases less compared to that obtained during training with training images.

### BRIEF SUMMARY OF THE INVENTION

At least one embodiment of the invention proposes to achieve at least one of the aforementioned goals by a computer-implemented method for training a neural network providing a digital signature for each image given as input to said neural network, said method comprising a first training phase of said neural network with a set of training images and a training algorithm aiming to minimize a first cost function.

The method according to one or mor embodiments of the invention is characterized in that it further comprises a second training phase comprising at least one iteration of the following steps:
providing an image originating from said set of training images to said neural network in order to obtain a so-called real signature,
generating at least one so-called artificial signature from said real signature,
calculating an error based upon said real and artificial signatures, and
updating at least one layer of said neural network, based upon said error, in order to minimize a second cost function.

Thus, at least one embodiment of the invention proposes training of, or learning by, a neural network in two phases. During the first training phase, the neural network is trained on a set of training images, in a conventional way. Then, during a second phase, the neural network, already trained during the first phase, undergoes a second training. This second training integrates, in the learning of the neural network, variations based on the signature provided by the neural network following its training during the first phase. These variations materialize as artificial signatures, obtained from the real signature, and which introduce an artificial error taken into account in the second cost function that the second training phase aims to minimize. Thus, the method according to one or more embodiments of the invention proposes training that allows the neural network to have a performance that is less dependent on variations, such as differences in brightness or viewing angle, between the images of the training set and the real images processed during the use thereof.

In at least one embodiment of the invention, “object re-identification” in images means re-identification of a person, an animal or an object, such as for example a vehicle.

According to one or more embodiments, the second training phase may comprise, prior to the update step, locking at least one layer of the neural network so that said at least one locked layer is not updated during the update step.

In other words, during at least one iteration, in particular all the iterations, of the second training phase the weights of each locked layer are not updated.

Locking one or more layers of the neural network makes it possible to keep, for these layers, the weights calculated during the first training phase and thus to keep the performance of the neural network trained on the images of the training set.

According to at least one embodiment, the number of layers locked during the second training phase is between 20 and 40, and in particular equal to 30.

During the second training phase, the update step can be performed using the same training algorithm as the first training phase.

This feature makes it possible to keep the results of the first training phase as much as possible.

Preferentially, in at least one embodiment, the training algorithm of the first training phase uses, or can be, the gradient backpropagation method.

Preferentially, in at least one embodiment, the training algorithm of the second training phase uses, or can be, a gradient backpropagation method.

According to one or more embodiments, at least one artificial signature may be generated from a normal distribution in which:
the mean matches the real signature;
the variance, in particular the normalized variance, is a predetermined value, for example 0.1.

Of course, it is possible to use any other function to generate at least one artificial signature from the real signature. Preferentially, in at least one embodiment, each artificial signature can match the real signature slightly modified, so as to take into account the slight variations that there may be in the images to be processed by the neural network, compared to the training images. These variations may comprise a variation in the angle at which the image is taken, a variation in brightness, etc.

According to one or more embodiments, for a real signature, the number of artificial signatures generated can be greater than 1, and in particular between 3 and 7, and even more particularly equal to 5.

Thus, the method according to one or more embodiments of the invention makes it possible to take into account slight variations in the images, without however increasing the computer resources and the time required for training the neural network.

According to one or more embodiments, the first cost function may be a double cost function taking into account a double error, namely:
a “triplet loss” or a “contrastive loss” or even a “circle loss” as defined on the page https://arxiv.org/pdf/2002.10857.pdf; and
a “loss identification” or classification error, for example a cross-entropy error as defined on the page https://www.tensorflow.org/api_docs/python/tf/keras/losses/CategoricalCr ossentropy.

Thus, for each image a triplet loss value and a classification loss error value are calculated.

According to at least one embodiment, the first cost function can comprise two components: a triplet cost component taking into account the triplet loss and a conventional classification cost component taking into account for example the cross-entropy error. In this case, the training algorithm can aim to minimize either each cost component individually, or the sum of two components.

Alternatively, in one or more embodiments, the first cost function may comprise a single cost component that takes into account a combination of the triplet loss and the conventional classification loss obtained for each image, for example an average of these errors for each image. In this case, the training algorithm may aim to minimize said single component.

The triplet loss, contrastive loss, circle loss, loss identification error or cross-entropy error are well known to the skilled person. It is therefore not necessary to detail them further herein for the sake of conciseness.

In one or more embodiments, the second cost function may be identical to the first cost function.

According to one or more embodiments, the second cost function can calculate a so-called aggregate error, taking into account, for example, by addition:
a so-called real error, calculated based upon the real signature;
a so-called artificial error, based upon each artificial signature, for example by averaging the artificial errors obtained for all the artificial signatures.

According to at least one embodiment, the real error can be a triplet loss or a loss identification error.

According to at least one embodiment, an artificial error is calculated for each real signature, for example a triplet loss or a loss identification error. Then, an artificial error average is calculated by averaging all the artificial errors obtained for all the artificial signatures. Finally, a total error is calculated by adding the real error and the average of the artificial errors. The training algorithm used during the second training phase aims to minimize a cost function by taking into account this total error for each training image.

According to at least one embodiment of the invention, a convolutional neural network trained by a training method according to one or more embodiments of the invention is proposed.

The neural network can be a CNN, like Resnet for example.

The neural network can comprise 50 layers.

According to at least one embodiment of the invention, a computer-implemented method for re-identifying objects in images implementing a neural network trained according to one or more embodiments of the invention is proposed.

In particular, the re-identification method according to one or more embodiments of the invention may comprise at least one iteration of the following steps:
generating, by said neural network, a first signature for a first image of a first object provided to said neural network;
generating, by said neural network, a second signature for at least one second image of a second object provided to said neural network; and
calculating a distance or a similarity between said first signature and said at least one second signature.

The calculated distance or similarity is then used to determine whether or not the second object matches the first object based upon at least one predefined distance or similarity threshold.

The method according to one or more embodiments of the invention can be used for re-identification of person(s) in images.

The method according to one or more embodiments of the invention can be used for re-identification of non-human object(s), such as a car, in images.

### BRIEF DESCRIPTION OF THE DRAWINGS

Other benefits and features shall become evident upon examining the detailed description of one or more embodiments, and from the enclosed drawings in which:

FIG. 1a is a schematic depiction of a non-limiting example of contrastive loss that can be used in one or more embodiments of the invention;

FIG. 1b is a schematic depiction of a non-limiting example of triplet loss that can be used in one or more embodiments of the invention;

FIG. 2 is a schematic depiction of a non-limiting example of a training method according to one or more embodiments of the invention; and

FIG. 3 is a schematic depiction of a non-limiting example of a re-identification method according to one or more embodiments of the invention.

### DETAILED DESCRIPTION OF THE INVENTION

It is understood that the embodiments disclosed hereunder are by no means limiting. In particular, it is possible to imagine variants of the invention that comprise only a selection of the features disclosed hereinafter in isolation from the other features disclosed, if this selection of features is sufficient to confer a technical benefit or to differentiate the invention with respect to the prior state of the art. This selection comprises at least one preferably functional feature which is free of structural details, or only has a portion of the structural details if this portion alone is sufficient to confer a technical benefit or to differentiate the invention with respect to the prior state of the art.

In particular, all of the described variants and embodiments can be combined with each other if there is no technical obstacle to this combination.

In the figures and in the remainder of the description, the same reference has been used for the features that are common to several figures.

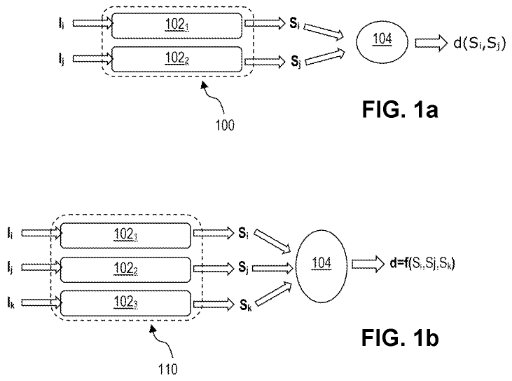

FIG. 1a is a schematic depiction of a non-limiting example of contrastive loss that can be used in one or more embodiments of the invention.

FIG. 1a depicts a signature generator 100 comprising two networks of neural networks, 102₁ and 102₂ of identical architectures. In other words, the neural network 102₁ is identical to the neural network 102₂. For example, the neural networks 102₁ and 102₂ may be Siamese neural networks.

The two neural networks 102₁ and 102₂ share exactly the same parameters. The updates of the parameters are synchronized across the two networks 102₁ and 102₂, that is to say that when the parameters of one of the networks 102₁ and 102₂ are updated, those of the other one of the networks 102₁ and 102₂ are also updated in the same way. Thus, at each time t, the values of the parameters of the networks 102₁ and 102₂ are exactly the same.

Each of the networks 102₁ and 102₂ takes an image as input and provides a digital signature for this image as output. A comparator 104 takes the signatures provided by each of the networks 102₁ and 102₂ as input. The comparator 104 is configured to determine a distance, for example the cosine or Euclidean distance, or a similarity, for example the cosine or Euclidean similarity, between the signatures provided by the neural networks 102₁ and 102₂.

In at least one embodiment, the neural network 102₁ produces a signature Sᵢ for the observation lᵢ and the neural network 102₂ produces a signature Sⱼ for the observation lⱼ. The comparator 104 determines the standardized cosine distance, denoted d(Sᵢ,Sⱼ), between the two signatures Sᵢ and Sⱼ. This distance d(Sᵢ,Sⱼ) should be minimized if the two signatures belong to the same entity, and maximized otherwise.

A cost function can then be defined, for example as a sum of all the distances obtained for all the training images. The algorithm for training a neural network aims to minimize the cost function thus defined.

FIG. 1b is a schematic depiction of a non-limiting example of triplet loss that can be used in one or more embodiments of the invention.

FIG. 1b shows a signature generator 110 comprising three neural networks 102₁, 102₂ and 102₃ of identical architecture, each intended to take an image as input and to provide a digital signal for this image as output. The three neural networks 102₁, 102₂ and 102₃ share exactly the same parameters. The updates of the parameters are synchronized across the three networks 102₁-102₃, that is to say that when the parameters of one of the networks 102₁-102₃ are updated, those of the other two of the networks 102₁-102₃ are also updated in the same way. Thus, at each time t, the values of the parameters of networks 102₁-102₃ are exactly the same.

Each of the networks 102₁-102₃ takes an image as input and provides a digital signature for this image as output.

A comparator 104 takes as input the signatures provided by each of the networks 102₁-102₃ and configured to compare these signatures to one another, for example by calculating the distance between these signatures taken two by two.

In at least one embodiment, the neural network 202₁ produces a signature Sᵢ for an image lᵢ, the neural network 202₂ produces a signature Sⱼ for an image lⱼ, identical to the image lᵢ, and the neural network 202₃ produces a signature Sₖ for an image lₖ different from the image lᵢ. The comparator 204 determines an error based upon the digital signatures Sᵢ, Sⱼ and Sₖ, with the digital signature Sᵢ as the anchor input, the signature Sⱼ as the positive input and the signature Sₖ as the negative input. More information on the Triplet Loss can be found on the page: https://fr.wikipedia.org/wiki/Fonction_de_co%C3%BBt_par_triplet

A cost function can then be defined, for example as being a sum of all the triplet losses obtained for all the training images. The algorithm for training a neural network aims to minimize the cost function thus defined.

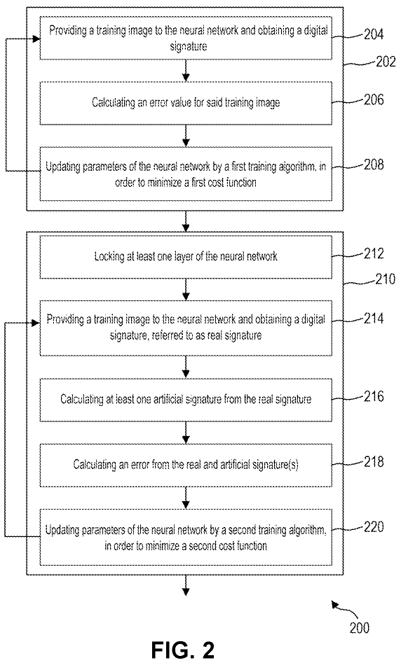

FIG. 2 is a schematic depiction of a non-limiting example of a method for training a neural network according to one or more embodiments of the invention.

The method 200 can be used to train a neural network used to generate a digital signature of an image given as input to said neural network.

The neural network can be a convolutional neural network, for example a 50-layer CNN Resnet.

The method 200 depicted in FIG. 2 includes a first training phase 202, according to one or more embodiments of the invention. This first phase performs conventional training of the neural network, using a set of training images, also referred to as training set hereinafter.

The training set can be a set of images from the academic world. For example, the training set can be any one, and preferably any combination, of the following image sets:
CHUK01, “Human Reidentificaiton with Transferred Metric Learning”, by Li Wei, Zhao Rui and Wang Wiaogang, ACCV, 2012
CHUK03, “DeepReID: Deep Filter Pairing Neural Network for Person Re-identification” by Li Wei, Zhao Rui, Xiao Tong and Wang Wiaogang, CVPR, 2014
Market1501, “Improving Person Re-identificiation by Attribute and Identity Learning”, by Lin Yutian, Zheng Liang, Zhang Zhedong,

In at least one embodiment, the first training phase comprises several iterations of the following steps.

During a step 204, an image is provided to the neural network. The latter then provides a digital signature for this image.

During a step 206, an error is calculated, for this image based upon the signature obtained during step 204. The error calculated during step 206 may be the “Contrastive Loss” described with reference to FIG. 1a. Alternatively, in at least one embodiment, the error calculated during step 206 may be the “Triplet Loss” described with reference to FIG. 1b.

Preferably, in one or more embodiments, the error calculated during step 206 may be a double error combining:
a “Triplet loss” or a “Contrastive loss” or even a “Circle loss” (https://arxiv.org/pdf/2002.10857.pdf); and
a “loss identification” error, for example a “cross-entropy” error (https://www.tensorflow.org/api_docs/python/tf/keras/losses/Categorica lCrossentropy).

During a step 208, the parameters of at least one layer of the neural network are updated in an attempt to minimize a first cost function taking into account all the errors calculated for all the training images. The parameters of the neural network are updated by a training algorithm, such as for example a gradient backpropagation algorithm.

Steps 204-208 are repeated as many times as desired until the neural network is sufficiently trained, that is to say until the first cost function is minimized, and even more particularly until the first cost function returns a value that is less than or equal to a predetermined threshold.

For example, in at least one embodiment, the first training phase 202 can be stopped, and the neural network can be considered sufficiently trained, when the first cost function no longer decreases during ten iterations of said first phase 202.

The method 200 depicted in FIG. 2 comprises a second training phase 210, using the neural network trained during the first training phase 202, according to one or more embodiments of the invention.

This second training phase 210 trains the neural network again, using, for example, the same set of training images as the one used during the first phase, but using a different cost function.

During a step 212 of this second training phase 210, a certain number of layers of the neural network are locked so that these layers will not be updated during the second training phase 210. For example, the number of locked layers can be equal to 30.

During a step 214, an image is provided to the neural network. The latter then provides a digital signature for this image. This signature, referred to as real signature and denoted Sᵣ hereinafter, is supposed to be a signature that perfectly matches this image since the neural network has already been trained during the first training phase 202.

During a step 216, N signature(s), referred to as artificial signature(s), are generated from the real signature provided in step 214 by the neural network. According to at least one embodiment, the artificial signatures are generated according to a normal distribution model of mean Sᵣ and variance V. According to a non-limiting exemplary embodiment, N=5 and V=0.1.

During a step 218, an error is calculated, based upon a part of the real signature Sᵣ and the at least one artificial signature.

The error calculated may be the “Contrastive Loss” described with reference to FIG. 1a.

According to at least one embodiment, an artificial error is calculated for each artificial signature. Then, an artificial error average is calculated by averaging all the artificial errors obtained for all the artificial signatures. Finally, a total error is calculated by adding the real error obtained for the real signature, and the average of the artificial errors.

During a step 220, the parameters of at least one layer of the neural network are updated in an attempt to minimize a second cost function that takes into account all the errors of all the training images, for example by addition. The parameters of the neural network are updated by a second training algorithm, such as for example a gradient backpropagation algorithm. During this update, the parameters of the layers locked in step 212 are not modified.

Steps 214-220 are repeated as many times as desired until the neural network is sufficiently trained, that is to say until the second cost function is minimized, in other words, when the second cost function returns a value that is less than or equal to a predetermined threshold.

For example, in at least one embodiment, the second training phase 210 may be stopped, and the neural network may be considered sufficiently trained, when the second cost function no longer decreases during ten iterations of said second training phase 210.

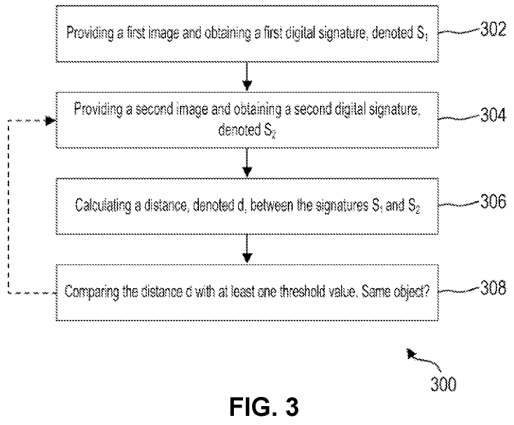

FIG. 3 is a schematic depiction of a non-limiting example of a re-identification method according to one or more embodiments of the invention.

The method 300 of FIG. 3 can be used for re-identifying objects or persons in images. It is noted that, in one or more embodiments, “object re-identification” is generally understood to mean re-identification of objects, persons, animals, etc.

The method 300 uses a neural network trained according to one or more embodiments of the invention, such as for example a neural network trained by the method 200 of FIG. 2.

The method 300 comprises a step 302 of providing a first image of a first object to the trained neural network. This step 302 provides a signature S₁.

The method 300 comprises a step 304 of providing a second image of a second object to the trained neural network. This step provides a signature S₂.

The neural network used during step 304 can be the same network as that used during step 302. In this case, steps 302 and 304 are carried out in turn.

Preferably, in at least one embodiment, the neural network used during step 304 is another neural network, identical to the neural network used during step 302. In other words, steps 302 and 304 use two Siamese neural networks. In this case, steps 302 and 304 can be carried out in turn, or, preferably, at the same time.

During a step 306, the signatures S₁ and S₂ are compared. For example, a distance d, for example the cosine or Euclidean distance, is calculated between the signatures S₁ and S₂.

This distance d is compared with a predetermined threshold value during a step 308. If the distance is less than the threshold value, then this indicates that the second object is the same as the first object. Otherwise, this indicates that the first object and the second object are different objects.

Thus, by repeating steps 304-308 on different images, it is possible to identify and track an object that appears on a first image.

Of course, the invention is not limited to the examples and embodiments disclosed above.

1. A computer-implemented method for training a neural network providing a digital signature for each image given as input to said neural network, said computer-implemented method comprising:
a first training phase of said neural network with a set of training images and a training algorithm aiming to minimize a first cost function, and
a second training phase comprising at least one iteration of
providing an image originating from said set of training images to said neural network in order to obtain a real signature,
generating at least one artificial signature from said real signature,
calculating an error based upon said real signature and said at least one artificial signature, and
updating at least one layer of said neural network, based upon said error, in order to minimize a second cost function.

2. The computer-implemented method according to claim 1, wherein the second training phase further comprises, prior to the updating, locking said at least one layer of the neural network so that said at least one layer that is locked is not updated during the updating.

3. The computer-implemented method according to claim 1, wherein the updating is performed using the training algorithm as the first training phase.

4. The computer-implemented method according to claim 1, wherein the training algorithm uses a gradient backpropagation method.

5. The computer-implemented method according to claim 1, wherein said at least one artificial signature is generated from a normal distribution in which a mean matches the real signature and a variance is a predetermined value, of 0.1.

6. The computer-implemented method according to claim 1, wherein, for said real signature, a number of artificial signatures generated is equal to five.

7. The computer-implemented method according to claim 1, wherein the first cost function is a double cost function taking into account a double error, said double error comprising
a triplet loss or a contrastive loss, and
a loss identification error or a classification error, comprising a cross-entropy.

8. The computer-implemented method according to claim 1, wherein the second cost function calculates an aggregate error, taking into account, by addition
a real error, calculated based upon the real signature;
an artificial error, calculated based upon each artificial signature of said at least one artificial signature, by averaging all artificial errors obtained for all artificial signatures of said at least one artificial signature.

9. A convolutional neural network trained by a computer-implemented training method for training said convolutional neural network providing a digital signature for each image given as input to said convolutional neural network, said computer-implemented training method comprising:
a first training phase of said convolutional neural network with a set of training images and a training algorithm aiming to minimize a first cost function, and
a second training phase comprising at least one iteration of
providing an image originating from said set of training images to said convolutional neural network in order to obtain a real signature,
generating at least one artificial signature from said real signature,
calculating an error based upon said real signature and said at least one artificial signature, and
updating at least one layer of said convolutional neural network, based upon said error, in order to minimize a second cost function.

10. A computer-implemented method for re-identifying objects in images implementing a neural network trained by the computer-implemented method ,the computer-implemented method comprising:
a first training phase of said neural network with a set of training images and a training algorithm aiming to minimize a first cost function, and
a second training phase comprising at least one iteration of
providing an image originating from said set of training images to said neural network in order to obtain a real signature,
generating at least one artificial signature from said real signature,
calculating an error based upon said real signature and said at least one artificial signature, and
updating at least one layer of said neural network, based upon said error, in order to minimize a second cost function.
